(19) United States
(12) Patent Application Publication
(10) Pub. No.: US 2026/0180833 A1
(43) Pub. Date: Jun. 25, 2026

(54) SYSTEM FOR PERFORMING SEMANTIC COMMUNICATION

(71) Applicant: University-Industry Cooperation Group of Kyung Hee University, Gyeonggi-do (KR)

(72) Inventors: CHOONG SEON HONG, Gyeonggi-do (KR); NGUYEN XUANLOC, Gyeonggi-do (KR); JI SU YOON, Gyeonggi-do (KR)

(21) Appl. No.: 19/400,338

(22) Filed: Nov. 25, 2025

(30) Foreign Application Priority Data
Dec. 23, 2024 (KR) 10-2024-0194727

(51) Int. Cl. H04L 25/02; H04L 25/03; H04L 45/02

(52) U.S. Cl. CPC H04L 25/0254; H04L 45/08; H04L 2025/03815

(57) ABSTRACT

A semantic communication system includes a base station including a semantic encoder configured to convert data to be transmitted into semantic information and a channel encoder configured to convert the converted semantic information into a channel signal and a plurality of user equipment devices (UEs) including a channel decoder configured to receive the channel signal and decode the channel signal into the semantic information and a semantic decoder configured to decode data included in the decoded semantic information based on the decoded semantic information.

### CROSS-REFERENCE TO RELATED APPLICATION AND CLAIM OF PRIORITY

This application claims the benefit under 35 USC § 119(a) of Korean Patent Application No. 10-2024-0194727, filed on Dec. 23, 2024, in the Korean Intellectual Property Office, the entire disclosure of which is incorporated herein by reference for all purposes.

### BACKGROUND

### 1. Field

Embodiments of the present disclosure relate to a technology for performing semantic communication in a wireless communication system.

### 2. Description of Related Art

A Wireless access systems are being widely deployed to provide various types of communication services, such as voice, data, and the like. In general, a wireless access system is a multiple access system capable of supporting communication with multiple users by sharing available system resources (bandwidth, transmit power, and the like). Examples of multiple access systems include code division multiple access (CDMA) systems, frequency division multiple access (FDMA) systems, time division multiple access (TDMA) systems, orthogonal frequency division multiple access (OFDMA) systems, single carrier frequency division multiple access (SC-FDMA) systems, and the like.

In recent years, due to the rapid increase in network-connected devices such as Internet-of-things (IoT), sensors, and the like, not only is the number of user equipment devices (UEs) that a base station (BS) has to serve within a given resource region increasing, but the amount of data and control information that the base station transmits/receives to/from the UEs the base station is serving is also growing.

However, since the amount of radio resources available to the base station for communication with UEs is finite, a new method is required for the base station to efficiently transmit downlink data and downlink control information to UEs using the finite radio resources. In addition, new methods are required to consider the different capabilities of UEs.

Examples of the related art include Korean Patent Laid-Open Publication No. 10-2021-0117611 (Sep. 29, 2021).

### SUMMARY

Embodiments of the present disclosure are directed to providing a method for performing semantic communication in a wireless communication system.

In one general aspect, there is provided a semantic communication system including a base station including a semantic encoder configured to convert data to be transmitted into semantic information and a channel encoder configured to convert the converted semantic information into a channel signal and a plurality of user equipment devices (UEs) including a channel decoder configured to receive the channel signal and decode the channel signal into the semantic information and a semantic decoder configured to decode data included in the decoded semantic information based on the decoded semantic information.

The semantic encoder may use a first deep learning model to extract features from the data and generate the semantic information based on the extracted features, and the channel encoder may use a second deep learning model to map the semantic information to a signal space and convert the semantic information into a signal transmittable over a wireless channel.

The channel decoder may use a third deep learning model to remove noise from the received channel signal based on channel state information and reconstruct the noise-removed signal into semantic information, and the semantic decoder may use a fourth deep learning model to restore data included in the reconstructed semantic information based on the reconstructed semantic information.

The first deep learning model and the third deep learning model may be configured with an architecture based on Swin Transformer, and the second deep learning model and the third deep learning model may be configured with a structure based on Kolmogorov-Arnold Networks (KAN).

The base station may further include a training channel decoder and a training semantic decoder, and the base station may train the semantic encoder, the channel encoder, the training channel decoder, and the training semantic decoder to perform encoding and decoding for performing semantic communication of original data over a wireless channel.

The semantic encoder may be trained to, when the original data is input, convert the input original data into semantic information, the channel encoder may be trained to, when the converted semantic information is input, convert the input semantic information into a channel signal, the training channel decoder may be trained to, when the converted channel signal is input, decode the input channel signal into semantic information, the training semantic decoder may be trained to, when the decoded semantic information is input, decode the input semantic information into data, and the base station may train the semantic encoder, the channel encoder, the training channel decoder, and the training semantic decoder to minimize a loss function between the decoded data output through the training semantic decoder and the original data.

When it is determined that training is completed, the base station may fix training parameters of the semantic encoder and the channel encoder and terminate training.

Each of the plurality of UEs may receive a channel signal from the semantic encoder and the channel encoder of the base station whose training has been completed and train the channel decoder and the semantic decoder.

The plurality of UEs may have different capabilities.

In another general aspect, there is provided a base station including a semantic encoder and a channel encoder for performing semantic communication over a wireless channel in a semantic communication system, in which the semantic encoder uses a first deep learning model to extract features from data to be transmitted and generate semantic information based on the extracted features, and the channel encoder uses a second deep learning model to map the semantic information to a signal space and convert the semantic information into a signal transmittable over the wireless channel.

The base station may further include a training channel decoder and a training semantic decoder, and the base station may train the semantic encoder, the channel encoder, the training channel decoder, and the training semantic decoder to perform encoding and decoding for performing semantic communication of original data over a wireless channel.

The semantic encoder may be trained to, when the original data is input, convert the input original data into semantic information, the channel encoder may be trained to, when the converted semantic information is input, convert the input semantic information into a channel signal, the training channel decoder may be trained to, when the converted channel signal is input, decode the input channel signal into semantic information, the training semantic decoder may be trained to, when the decoded semantic information is input, decode the input semantic information into data, and the base station may train the semantic encoder, the channel encoder, the training channel decoder, and the training semantic decoder to minimize a loss function between the decoded data output through the training semantic decoder and the original data.

When it is determined that training is completed, the base station may fix training parameters of the semantic encoder and the channel encoder and terminate training.

In still another general aspect, there is provided a plurality of UEs including a channel decoder and a semantic decoder for performing semantic communication over a wireless channel in a semantic communication system, in which the channel decoder uses a third deep learning model to remove noise from a channel signal received over the wireless channel based on channel state information and reconstruct the noise-removed signal into semantic information, and the semantic decoder uses a fourth deep learning model to restore data included in the reconstructed semantic information based on the reconstructed semantic information.

Each of the plurality of UEs may receive a channel signal from the semantic encoder and the channel encoder of a base station whose training has been completed and train the channel decoder and the semantic decoder.

### BRIEF DESCRIPTION OF THE DRAWINGS

FIG. 1 is a view showing a semantic communication system according to an embodiment of the present disclosure.

FIG. 2 is a diagram showing a configuration of the semantic communication system according to an embodiment of the present disclosure.

FIG. 3 is a diagram illustrating a process of training a transmitter of a base station of the semantic communication system according to an embodiment of the present disclosure.

FIG. 4 is a diagram illustrating a process of training receivers of a plurality of UEs of the semantic communication system according to an embodiment of the present disclosure.

FIG. 5 is a block diagram exemplarily illustrating a computing environment that includes a computing device suitable for use in exemplary embodiments.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice, the intention of a user or operator, or the like. Thus, the definitions should be determined based on the overall content of the present specification. The terms used in the detailed description are only for describing the embodiments of the present disclosure, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but is should not be interpreted to preclude one or more other characteristics, numbers, steps, operations, elements, and a portion or combination thereof.

Further, it will be understood that, although the terms first, second, etc. may be used herein to describe various elements, these elements should not be limited by these terms. These terms may be used to distinguish one element from another element. For example, without departing from the scope of the present disclosure, a first element could be termed a second element, and similarly, a second element could be termed a first element.

In the following description, the terminology “transmission”, “communication”, “reception” of a signal or information and terminology similar thereto may include a meaning in which the signal or information is directly transmitted from one element to another element and transmitted from one element to another element through an intervening element. In particular, “transmission” or “sending” of the signal or information to one element may indicate a final destination of the signal or information and may not imply a direct destination. The same is true for “reception” of the signal or information. In addition, in the present specification, a meaning in which two or more pieces of data or information are “related” indicates that when any one piece of data (or information) is obtained, at least a portion of other data (or information) may be obtained based thereon.

Further, it will be understood that, although the terms first, second, etc. may be used herein to describe various elements, these elements should not be limited by these terms. These terms may be used to distinguish one element from another element. For example, without departing from the scope of the present disclosure, a first element could be termed a second element, and similarly, a second element could be termed a first element.

Meanwhile, the embodiments of the present disclosure may include a program for performing the methods described herein on a computer, and a computer-readable recording medium including the program. The computer-readable recording medium may include program instructions, a local data file, a local data structure, or the like alone or in combination. The media may be specially designed and configured for the present disclosure, or may be commonly used in the field of computer software. Examples of computer-readable recording media include magnetic media such as hard disks, floppy disks and magnetic tapes, optical recording media such as a CD-ROM and a DVD, and hardware devices specially configured to store and execute program instructions such as a ROM, a RAM, and a flash memory. Examples of the program may include not only machine language codes such as those produced by a compiler, but also high-level language codes that may be executed by a computer using an interpreter or the like.

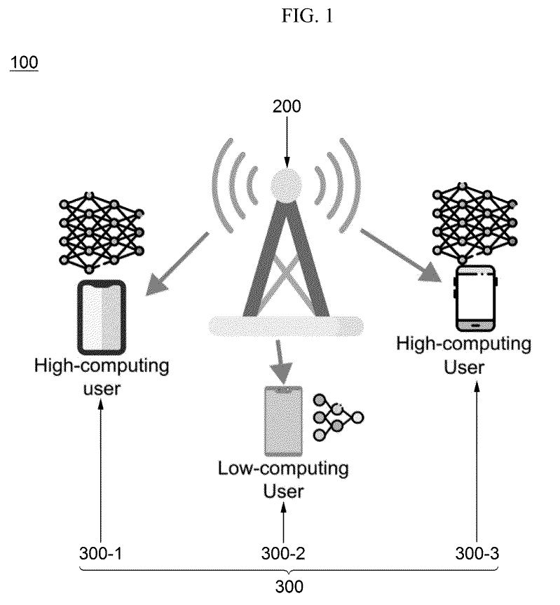

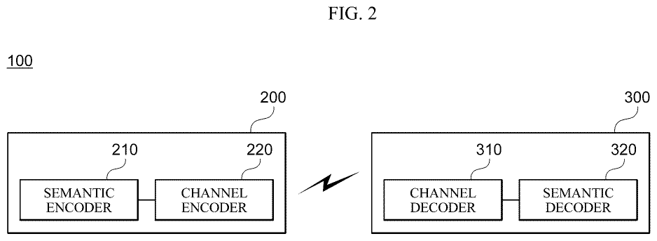

FIG. 1 is a view showing a semantic communication system according to an embodiment of the present disclosure, and FIG. 2 is a diagram showing a configuration of the semantic communication system according to an embodiment of the present disclosure.

As shown in FIGS. 1 and 2, a semantic communication system 100 according to an embodiment of the present disclosure may include a base station (BS) 200 and a plurality of user equipment devices (UEs) 300.

The term base station to be used below generally refers to a fixed station that communicates with wireless devices, and may be, for example, an evolved-NodeB (eNodeB or eNB), a Next-Generation NodeB (gNB), a base transceiver system (BTS), an access point, or the like.

In addition, the term user equipment to be used below may be fixed or mobile, and may be, for example, a device, a wireless device, a terminal, a mobile station (MS), a user terminal (UT), a subscriber station (SS), a mobile terminal (MT), or the like.

Meanwhile, the semantic communication system is for transmitting semantic information (the meaning information) of data to effectively reduce the volume of data transmitted and, at the same time, ensure reliability during a transmission process. To this end, both a transmitter and a receiver need to have the ability to understand semantic information, that is, need to be trained. Training may involve converting the data to be transmitted into another form of meaningful data within a neural network. Here, semantic information may be features or representations into which data has been converted through a trained neural network. That is, through the trained neural network, the transmitter may extract only the main content or meaningful information in the data to transmit semantic information, and the receiver may receive only the semantic information, instead of the entire data, so that the meaning of the original data may be fully understood.

However, semantic communication systems in the related art use uniformly trained neural networks, which leads to problems of degraded reliability and stability depending on the capabilities of the UE.

Therefore, the semantic communication system according to an embodiment of the present disclosure is for efficiently supporting semantic communication for UEs having different capabilities, thereby increasing the reliability and stability of semantic communication.

Referring again to FIG. 2, the BS 200 may include a semantic encoder 210 and a channel encoder 220. In addition, the plurality of UEs 300 may include a channel decoder 310 and a semantic decoder 320. Here, the plurality of UEs 300 may have different capabilities. The capabilities of the UEs 300 may be computation-related capabilities such as computing performance-based processing power (e.g., supported network types, number of layers, number of nodes, connection methods, and the like), types of executable operations (e.g., channel estimation, multi-input multi-output (MIMO) reception, data encoding/decoding, and the like), and the like.

The semantic encoder 210 may convert data to be transmitted into semantic information. Specifically, the semantic encoder 210 may perform encoding to convert the data to be transmitted into semantic information. Here, the semantic information may be information on the meaning of data (e.g., images, text, or the like). Such semantic information may be features or representations into which data is converted through the semantic encoder 210.

In an exemplary embodiment, the semantic encoder 210 may use a first deep learning model to extract features from data and generate semantic information based on the extracted features. In this case, the data may be images, videos, controls, text, and the like. For example, when image data is input, the first deep learning model may convert the image data into a vector, extract a feature vector based on the converted vector and generate semantic information. In addition, the first deep learning model is configured with a Swin Transformer architecture, and may reduce computational complexity and extract both global and local information through hierarchical representation. Meanwhile, although the present disclosure is described as being configured with the Swin Transformer architecture, the present disclosure is not limited thereto, and other neural network structures that extract features from input data may be used.

The channel encoder 220 may convert semantic information converted by the semantic encoder 210 into a channel signal. Specifically, the channel encoder 220 may perform encoding to convert the semantic information into the channel signal.

In an exemplary embodiment, the channel encoder 220 may use a second deep learning model to convert the semantic information into the channel signal transmittable over a wireless channel. For example, the second deep learning model may map the feature vector to a signal space and convert the mapped feature vector into a signal that may be transmitted over the wireless channel. In addition, the second deep learning model is configured with Kolmogorov-Arnold Networks (KAN), and may use a trainable one-dimensional function to compress data into a low dimensional representation while preserving key patterns. Meanwhile, although the present disclosure is described as being configured with the KAN, the present disclosure is not limited thereto, and another neural network structure that converts the semantic information into a signal that may be transmitted over the wireless channel may be used.

The channel decoder 310 may decode the channel signal received over the wireless channel into semantic information. Specifically, the channel decoder 310 may perform decoding to reconstruct the channel signal received over the wireless channel into semantic information.

In an exemplary embodiment, the channel decoder 310 may use a third deep learning model to reconstruct semantic information based on the channel signal. In this case, since the wireless channel operates under the environment where channel distortion and noise are inevitable, noise (additive white Gaussian noise (AWGN)), interference, and fading (Rayleigh fading) need be considered. That is, the received channel signal may be expressed as in Equation 1 below.

$${Y}_{I , k} = {H}_{k} \cdot {X}_{I , k} + {N}_{k} \qquad [ Equation 1 ]$$

(where YI,k denotes the signal received by a UE k for the transmitted image I, Hk denotes the channel coefficient, XI,k denotes the transmitted signal, and Nk denotes the complex noise vector)

In this way, the third deep learning model may correct channel state information in the received signal to remove noise and reconstruct the noise-removed signal into semantic information. In addition, the third deep learning model may be configured with the Swin Transformer architecture.

The semantic decoder 320 may decode data included in the decoded semantic information based on the decoded semantic information. Specifically, the semantic decoder 320 may perform decoding to restore the decoded semantic information to original data.

In an exemplary embodiment, the semantic decoder 320 may use a fourth deep learning model to restore the semantic information to the original data. For example, the fourth deep learning model may restore (convert) the feature vector estimated through the channel decoder 310 into an image. That is, the fourth deep learning model may reconstruct the original image transmitted from the base station (transmitter) based on the feature vector estimated through the channel decoder 310. In this case, the fourth deep learning model may be trained to minimize a mean squared error (MSE) between the original image and the restored image.

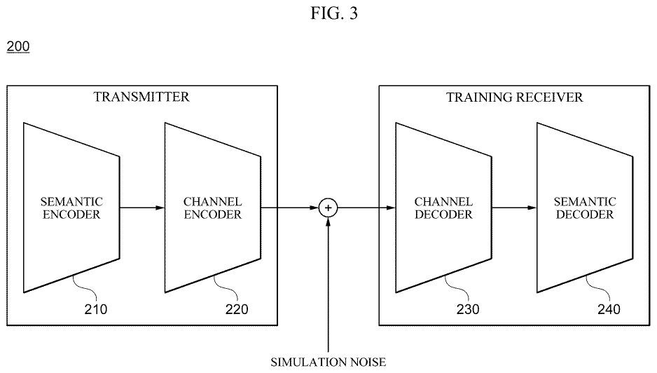

FIG. 3 is a diagram illustrating a process of training a transmitter of the base station of the semantic communication system according to an embodiment of the present disclosure. Components corresponding to the components in the embodiments of the present disclosure described with reference to FIGS. 1 and 2 perform the same or similar functions as those described in the embodiments, and thus a detailed description thereof will be omitted.

Referring to FIG. 3, the BS 200 of the semantic communication system according to an embodiment of the present disclosure may include a transmitter (the semantic encoder 210 and the channel encoder 220) and a training receiver (a training channel decoder 230 and a training semantic decoder 240). In this case, the training channel decoder 230 and the training semantic decoder 240 of the training receiver may be temporary deep learning models generated to train the semantic encoder 210 and the channel encoder 220 of the transmitter. In addition, the training channel decoder 230 and the training semantic decoder 240 may be formed in a symmetrical structure with the semantic encoder 210 and the channel encoder 220. In this way, it is possible to significantly improve the performance of the semantic encoding process.

The BS 200 may learn an encoding and decoding process for data transmission and reception using the semantic encoder 210, the channel encoder 220, the training channel decoder 230, and the training semantic decoder 240. In this case, since data is not transmitted over a wireless channel during the learning process, an environment similar to the wireless channel may be generated by adding simulation noise during the data transmission process between the transmitter and the training receiver.

In an exemplary embodiment, the BS 200 may train the semantic encoder 210 to convert original data into semantic information. In addition, the BS 200 may train the channel encoder 220 to convert the converted semantic information into a channel signal. Then, the converted channel signal may be transmitted to the training channel decoder 230, and simulation noise may be added during the transmission process. In addition, the BS 200 may train the training channel decoder 230 to decode the converted channel signal into semantic information. In addition, the BS 200 may train the training semantic decoder 240 to decode the decoded semantic information into data. In this case, the BS 200 may train the semantic encoder 210, the channel encoder 220, the training channel decoder 230, and the training semantic decoder 240 to minimize the loss function (e.g., mean square error) between the decoded data output through the training semantic decoder 240 and the original data.

Through the training process described above, when the decoded data output from the training receiver of the BS 200 becomes sufficiently similar to the original data, the signal output through the encoding process performed in the transmitter of the BS 200 may be efficiently transmitted, it may be determined that the signal sufficiently contains semantic information, and training may be completed. Then, the parameters of the semantic encoder 210 and the channel encoder 220 may be fixed. Accordingly, by excluding the influence of the receiver of the UE 300 in the process of training the semantic encoder 210 and the channel encoder 220, the transmitter of the BS 200 may be stably trained, and since the training receiver is independent in structure from the receiver of the UE 300, the receiver of the UE 300 may be configured with a more free structure.

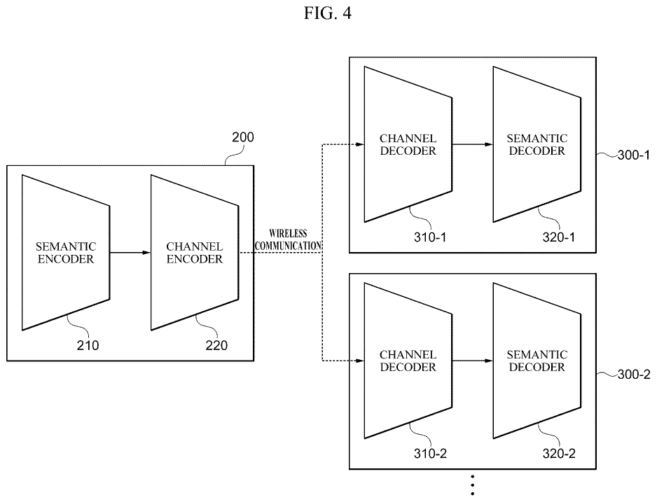

FIG. 4 is a diagram illustrating a process of training receivers of a plurality of UEs of the semantic communication system according to an embodiment of the present disclosure. Components corresponding to the components in the embodiments of the present disclosure described with reference to FIGS. 1 and 2 perform the same or similar functions as those described in the embodiments, and thus a detailed description thereof will be omitted. However, in the present embodiment, the semantic encoder 210 and the channel encoder 220 of the BS 200 may be in a state where training has been completed, that is, the training parameters may be fixed.

Referring to FIG. 4, a plurality of UEs 300 of the semantic communication system according to an embodiment of the present disclosure may include a receiver (the channel decoder 310 and the semantic decoder 320). In this case, the receiver of each of UEs 300-1 and 300-2 may have a different neural network structure depending on the performance of the UEs 300. The capabilities of the UEs 300 may be computation-related capabilities such as computing performance-based processing power (e.g., supported network types, number of layers, number of nodes, connection methods, and the like), types of executable operations (e.g., channel estimation, multi-input multi-output (MIMO) reception, data encoding/decoding, and the like), and the like.

The plurality of UEs 300 may learn a decoding process for data transmission and reception by receiving the channel signal from the semantic encoder 210 and the channel encoder 220 of the BS 200 whose training has been completed.

In an exemplary embodiment, the UE 300 may train the channel decoder 310 to decode a channel signal into semantic information. In addition, the UE 300 may train the semantic decoder 320 to decode the decoded semantic information into data. In this case, the UE 300 may train the channel decoder 310 and the semantic decoder 320 so that the loss function (e.g., mean square error) between the decoded data output through the semantic decoder 320 and the original data is minimized. The UE 300 may train the channel decoder 310 and the semantic decoder 320 to be optimized using a gradient descent method based on the loss function. In addition, the UE may be in a state where the original data is pre-stored.

Through the aforementioned training process, each of the plurality of UEs 300-1 and 300-2 may train the channel decoders 310-1 and 310-2 and the semantic decoders 320-1 and 320-2 depending on the capabilities of the UE. In addition, since the transmitter of the BS 200 has already been trained, the training processes of the plurality of UEs 300 do not affect each other, so that the plurality of UEs 300 may simultaneously learn.

Therefore, according to embodiments of the present disclosure, since semantic communication may be efficiently performed in a wireless communication system, a wireless communication signal may be efficiently transmitted.

In addition, according to embodiments of the present disclosure, semantic communication for UEs having different capabilities may be efficiently supported.

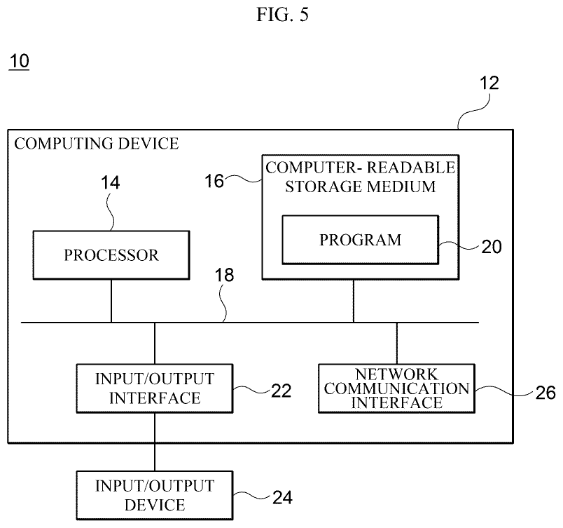

FIG. 5 is a block diagram exemplarily illustrating a computing environment 10 that includes a computing device suitable for use in exemplary embodiments. In the illustrated embodiment, each component may have a different function and capability in addition to those described below, and additional components may be included in addition to those described below.

The illustrated computing environment 10 includes a computing device 12. In an embodiment, the computing device 12 may be the BS 200. In addition, the computing device 12 may be the UE 300.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In one embodiment, the computer-readable storage medium 16 may be a memory (a volatile memory such as a random access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as one of components constituting the computing device 12, or may be connected to a computing device 12 as a separate device distinct from the computing device 12.

According to embodiments of the present disclosure, by efficiently performing semantic communication in a wireless communication system, a wireless communication signal can be efficiently transmitted.

In addition, according to embodiments of the present disclosure, semantic communication can be efficiently supported for UEs having different capabilities.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

What is claimed is:

1. A semantic communication system comprising:
a base station including a semantic encoder configured to convert data to be transmitted into semantic information and a channel encoder configured to convert the converted semantic information into a channel signal; and
a plurality of user equipment devices (UEs) including a channel decoder configured to receive the channel signal and decode the channel signal into the semantic information and a semantic decoder configured to decode data included in the decoded semantic information based on the decoded semantic information.

2. The semantic communication system of claim 1, wherein the semantic encoder uses a first deep learning model to extract features from the data and generate the semantic information based on the extracted features, and
is the channel encoder uses a second deep learning model to map the semantic information to a signal space and convert the semantic information into a signal transmittable over a wireless channel.

3. The semantic communication system of claim 2, wherein the channel decoder uses a third deep learning model to remove noise from the received channel signal based on channel state information and reconstruct the noise-removed signal into semantic information, and
the semantic decoder uses a fourth deep learning model to restore data included in the reconstructed semantic information based on the reconstructed semantic information.

4. The semantic communication system of claim 3, wherein the first deep learning model and the third deep learning model are configured with an architecture based on Swin Transformer, and
the second deep learning model and the third deep learning model are configured with a structure based on Kolmogorov-Arnold Networks (KAN).

5. The semantic communication system of claim 1, wherein the base station further includes a training channel decoder and a training semantic decoder, and
the base station trains the semantic encoder, the channel encoder, the training channel decoder, and the training semantic decoder to perform encoding and decoding for performing semantic communication of original data over a wireless channel.

6. The semantic communication system of claim 5, wherein the semantic encoder is trained to, when the original data is input, convert the input original data into semantic information,
the channel encoder is trained to, when the converted semantic information is input, convert the input semantic information into a channel signal,
the training channel decoder is trained to, when the converted channel signal is input, decode the input channel signal into semantic information,
the training semantic decoder is trained to, when the decoded semantic information is input, decode the input semantic information into data, and
the base station trains the semantic encoder, the channel encoder, the training channel decoder, and the training semantic decoder to minimize a loss function between the decoded data output through the training semantic decoder and the original data.

7. The semantic communication system of claim 6, wherein when it is determined that training is completed, the base station fixes training parameters of the semantic encoder and the channel encoder and terminates training.

8. The semantic communication system of claim 7, wherein each of the plurality of UEs receives a channel signal from the semantic encoder and the channel encoder of the base station whose training has been completed and trains the channel decoder and the semantic decoder.

9. The semantic communication system of claim 8, wherein the plurality of UEs have different capabilities.

10. A base station comprising:
a semantic encoder and a channel encoder for performing semantic communication over a wireless channel in a semantic communication system,
wherein the semantic encoder uses a first deep learning model to extract features from data to be transmitted and generate semantic information based on the extracted features, and
the channel encoder uses a second deep learning model to map the semantic information to a signal space and convert the semantic information into a signal transmittable over the wireless channel.

11. The base station of claim 10, further comprising a training channel decoder and a training semantic decoder,
wherein the base station trains the semantic encoder, the channel encoder, the training channel decoder, and the training semantic decoder to perform encoding and decoding for performing semantic communication of original data over the wireless channel.

12. The base station of claim 11, wherein the semantic encoder is trained to, when the original data is input, convert the input original data into semantic information,
the channel encoder is trained to, when the converted semantic information is input, convert the input semantic information into a channel signal,
the training channel decoder is trained to, when the converted channel signal is input, decode the input channel signal into semantic information,
the training semantic decoder is trained to, when the decoded semantic information is input, decode the input semantic information into data, and
the base station trains the semantic encoder, the channel encoder, the training channel decoder, and the training semantic decoder to minimize a loss function between the decoded data output through the training semantic decoder and the original data.

13. The base station of claim 12, wherein when it is determined that training is completed, the base station fixes training parameters of the semantic encoder and the channel encoder and terminates training.

14. A plurality of user equipment devices (UEs) comprising:
a channel decoder and a semantic decoder for performing semantic communication over a wireless channel in a semantic communication system,
wherein the channel decoder uses a third deep learning model to remove noise from a channel signal received over the wireless channel based on channel state information and reconstruct the noise-removed signal into semantic information, and
the semantic decoder uses a fourth deep learning model to restore data included in the reconstructed semantic information based on the reconstructed semantic information.

15. The plurality of UEs of claim 14, wherein each of the plurality of UEs receives a channel signal from a semantic encoder and a channel encoder of a base station whose training has been completed and trains the channel decoder and the semantic decoder.
